(19) United States
(12) Patent Application Publication
(10) Pub. No.: US 2008/0110540 A1
(43) Pub. Date: May 15, 2008

(54) Pneumatic tire

(76) Inventor: Samual Patrick Landers, North Canton, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/595,680

(22) Filed: Nov. 10, 2006

(51) Int. Cl. B60C 11/03

(52) U.S. Cl. 152/209.8

(57) ABSTRACT

A pneumatic tire has a tread with the radially outermost surface of the tread defining a circumferential length of the tire. The tread has a circumferentially extending groove. The circumferentially extending groove has repeating segments wherein the circumferential length of each repeating segment is at least 6.25% of the tire circumferential length. The repeating segments have an extent in the lateral direction of the tread, wherein, each directly adjacent repeating segment extends in opposite lateral directions.

### FIELD OF THE INVENTION

The present invention is directed to a pneumatic tire. More specifically, the present invention is directed to a pneumatic tire having a tire tread with a circumferential groove have a long length repeating pattern.

### BACKGROUND OF THE INVENTION

In a conventional pneumatic tire, particularly a high-performance tire, the tread pattern is generally formed by combining circumferential grooves extending along the circumferential direction of the tire with a plurality of grooves inclined relative to the circumferential direction. The combination of grooves forms a plurality of tread blocks along the radially outer surface of tire. If the inclined grooves do not extend completely between circumferential grooves, ribs are generated in the tire tread.

Rib tires with straight circumferential grooves are generally known to be quieter and have better hydroplaning resistance than tires with grooves that interlock. However, tires with substantially straight grooves are susceptible to groove wander, i.e. tracking on road grooves, and have poorer snow cleaning capability.

### SUMMARY OF THE INVENTION

The present invention is directed to a pneumatic tire wherein the tread is provided with at least one circumferentially extending groove that has a low amplitude, low frequency pattern about the tire circumference. Due to the groove configuration, the resulting tread elements maintain most of its straight groove noise and hydroplaning advantages while minimizing groove wander tendencies and providing some snow clearing capability.

In accordance with one aspect of the invention, a pneumatic tire has a tread with the radially outermost surface of the tread defining a circumferential length of the tire. The tread has a circumferentially extending groove. The circumferentially extending groove has repeating segments wherein the circumferential length of each repeating segment is at least 6.25% of the tire circumferential length. The repeating segments have an extent in the lateral direction of the tread, wherein, each directly adjacent repeating segment extends in opposite lateral directions.

In accordance with other aspects of the invention, the repeating segment circumferentially extending groove may be symmetrically or asymmetrically located in the tread. There may be only one repeating segment circumferentially extending groove in the tread or multiple repeating segment circumferentially extending grooves in the tread.

In accordance with another aspect of the invention, the circumferentially extending groove has at least six but not more than sixteen repeating segments, creating a pattern that repeats three to eight times about the circumference of the tire. Thus, achieving a low frequency meandering pattern about the tire.

In accordance with another aspect of the invention, the amplitude of the meandering pattern is also limited. For each repeating segment of the circumferential groove the lateral extent WA is in the range of 5 to 40% of the circumferential segment length LS. Preferably, the lateral extent WA is in the range of 5 to 25% of the circumferential segment length LS.

In accordance with another aspect of the invention, the low amplitude repeating pattern of the circumferential groove is either a sinusoidal or zig-zag pattern.

### BRIEF DESCRIPTION OF THE DRAWINGS

The invention will be described by way of example and with reference to the accompanying drawings in which:

FIG. 1 is a pneumatic tire having a tread with a low amplitude, low frequency meandering circumferential groove;

FIG. 2 is an exploded view of the tread of FIG. 1; and

FIGS. 3-5 are alternative embodiments of the tire tread.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims.

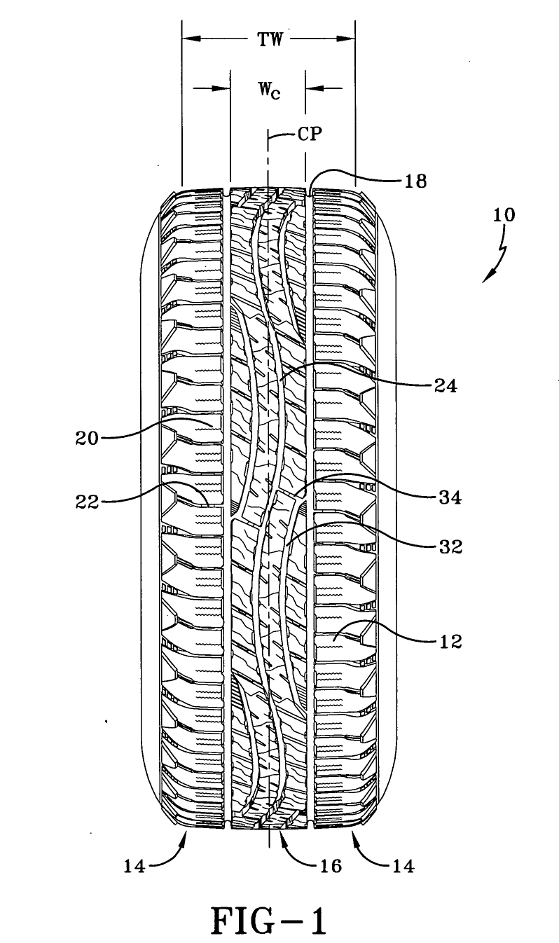

A tire 10 is illustrated in FIG. 1. On the radially outermost surface of the tire 10 is a tread 12. The tread 12 is divided into three regions: two opposing shoulder regions 14 and a central region 16. The regions 14, 16 are divided by continuous circumferentially extending grooves 18. The central region 16 has a width Wc in the range of 30 to 70% of the tread width TW, and by definition is centrally located in the tread 12. The shoulder regions 14 are located on opposing sides of the central tread region 16. In the shoulder regions 14 are a series of repeating tread elements, illustrated as tread blocks 20 separated by lateral grooves 22.

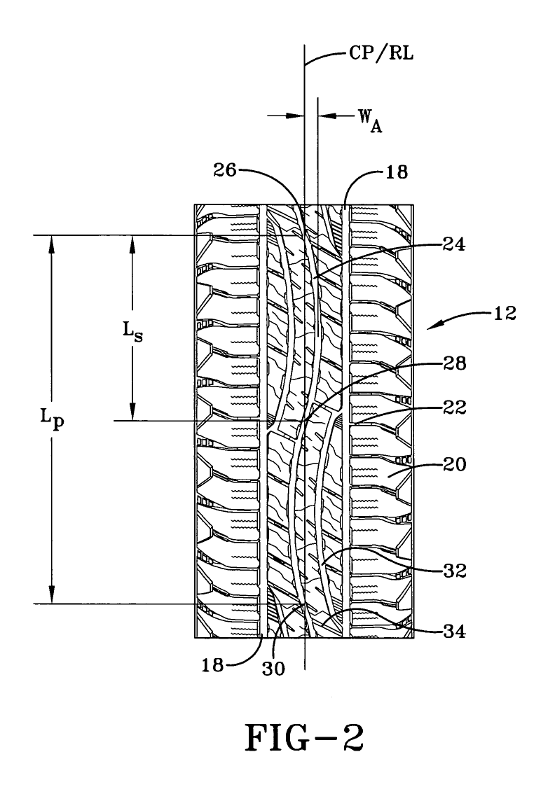

In the central tread region 16 is at least one non-straight continuous circumferentially extending groove 24. The groove 24 has a lateral component to it, creating a lateral extent WA. To create the continuous groove, and prevent the groove from “walking” across the tread, for each groove portion that shifts in one lateral direction, there is a portion of the groove that shifts in the opposite lateral direction. Each portion may be considered a repeating groove segment, wherein an adjacent pair of segments is a repeating groove pattern having a beginning point, a mid-point and an end-point. In the groove 24 of FIGS. 1 and 2, the repeating pattern is a sinusoidal curve, having a length L_{P}, with the beginning, mid, and end points 26, 28, 30. The curve has two circumferentially displaced, mirror image groove segments of length L_{S}; with each groove segment having a lateral extent W_{A} from the center plane CP.

The length LS is measured parallel to a reference line RL; said reference line RL is parallel to the center plane CP and connects the beginning, mid, and end points 26, 28, 30. For the tire 10 of FIGS. 1 and 2, the reference line RL is coincident with the tread center plane CP and the groove 24 repeatedly crosses the center plane CP. The segment length L_{S} of each groove segment is at least 1/16, or about 6.25%, of the circumferential length of the tire tread 12. The preferred maximum segment length LS is ⅙, or about 16% of the circumferential length of the tire tread 12. This results in anywhere from 3 to 8 repeating sinusoidal curves about the circumference of the tire 10.

Each groove segment has an lateral extent WA, as measured from the reference line RL to the center of the groove 24. The lateral extent WA is at least equal to 5% of the tread width TW. The lateral extent WA of each groove segment is also in the range of 5 to 40% of the circumferential segment length LS. Preferably, the lateral extent WA is in the range of 5 to 25% of the circumferential segment length LS.

Also within the central tread region 16 are a plurality of short length circumferentially extending grooves 32. The short length grooves 32 have a configuration that mimics or is substantially similar to the laterally adjacent portion of the continuous circumferential groove 24. The short length grooves 32 are located between circumferential grooves 18 that delineate the central tread region 16 and the continuous circumferential groove 24 in the central tread region. The short length grooves 32 assist in forming smaller tread elements than would otherwise be present in the tread absent the presence of such grooves 32. This assists in both the noise and wet driving characteristics of the tire 10.

To further divide the long rib-like tread elements on either side of the circumferential groove 24, a plurality of lateral grooves 34 are provided. The illustrated lateral grooves 34 initiate at both circumferential grooves 18 and a majority of the lateral grooves 34 appear to cross the at least one circumferential groove 24 or 32 in the central tread region 16.

The segment lengths LS in FIG. 2 are illustrated as having the same lengths. To prevent generation of a repetitive harmonic from the groove 24, the segment lengths LS may be slightly varied around the circumference of the tire. Another method to reduce noise in the tire tread is to vary the spacing of the lateral grooves located in the extending tread elements on each side of the groove 24.

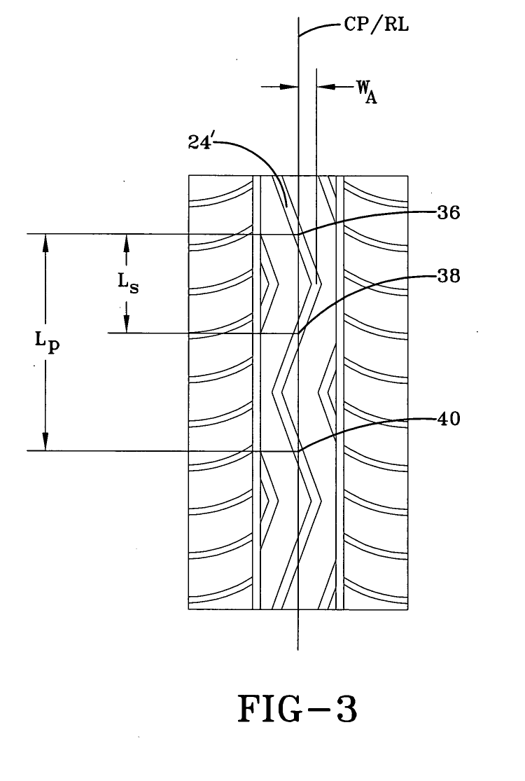

While the groove 24 of FIG. 1 has a repeating sinusoidal pattern with each groove segment being curved, the circumferential groove may have zig-zag configuration, see FIG. 3. The groove pattern length LP of the zig-zag groove 24′ is still measured between a beginning point 36 and an end point 40 of the groove pattern wherein the groove is coincident with the pattern reference line RL at the beginning point 36, a mid-point 38, and the end point 40. The remaining features in the tread of FIG. 3 are merely for illustrative purposes and may be selected to achieve the desired tire characteristics.

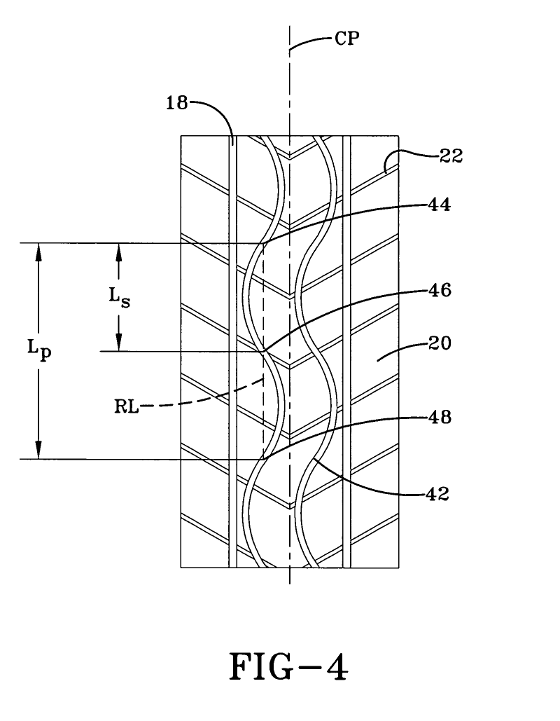

FIG. 4 illustrates another embodiment of the tread containing the long repeating pattern groove. The tread central portion has two sinusoidal grooves 42 located therein. The reference line RL is parallel to the center plane CP and passes through a beginning point 44, mid-point 46, and end point 48 of the repeating pattern.

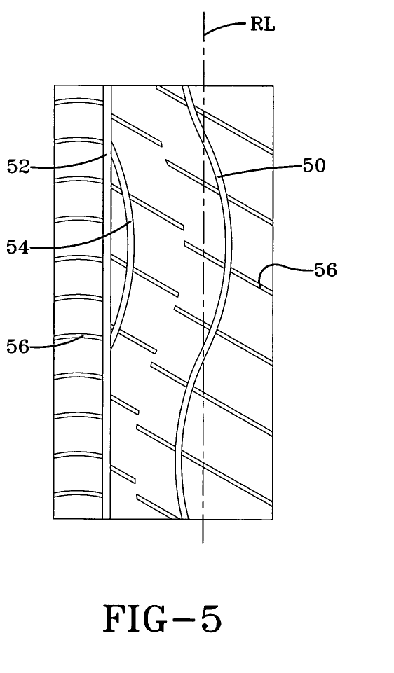

FIG. 5 illustrates another embodiment of the tread having the long repeating pattern groove. The tread has a sinusoidal groove 50 located in only one side of the tread. In the opposing tread half is a straight circumferentially extending groove 52. A plurality of short length circumferential grooves 54 and lateral grooves 56 assist in forming tread elements. In this embodiment, the sinusoidal groove 50 assists in delineating the central tread region 16 from the shoulder regions 14.

It is within the scope of this invention to have the low amplitude, low frequency meandering groove 24, 24′, 42, 50 at any location within the tread pattern. For all of the embodiments illustrated and those encompassed by the scope of the present disclosure and appended claims herein, the resulting tire, due to the presence of the low amplitude, low frequency meandering circumferential groove, maintain most of its straight groove noise and hydroplaning advantages, in comparison to a straight rib tire, while minimizing groove wander tendencies and providing some snow clearing capability.

What is claimed is:

1. A pneumatic tire, the tire having a tread, a radially outermost surface of the tread defining a circumferential length of the tire, the tread comprising a circumferentially extending groove, the circumferentially extending groove having repeating segments, the repeating segments having an extent in the lateral direction of the tread, wherein, each directly adjacent repeating segment extends in opposite lateral directions and the circumferential length of each repeating segment is at least 6.25% of the tire circumferential length.

2. The tire of claim 1 wherein the circumferentially extending groove has at least six but not more than sixteen repeating segments.

3. The tire of claim 1 wherein, for each repeating segment of the circumferential groove the lateral extent WA is in the range of 5 to 40% of the circumferential segment length LS.

4. The tire of claim 1 wherein, for each repeating segment of the circumferential groove, the lateral extent WA is in the range of 5 to 25% of the circumferential segment length LS.

5. The tire of claim 1 wherein the circumferentially extending groove is located in the central region of the tire tread.

6. The tire of claim 1 wherein the circumferentially extending groove repeatedly crosses the center plane of the tire tread.

7. The tire of claim 1 wherein, laterally adjacent to each repeating segment of the circumferential groove is a short length circumferentially extending groove having a configuration substantially similar to the adjacent repeating segment.

8. The tire of claim 1 wherein the tread is further provided with a pair of circumferential grooves, one groove on each lateral side of the repeating segment circumferentially extending groove.

9. The tire of claim 1 wherein the circumferential groove has either a sinusoidal or zig-zag configuration.

10. The tire of claim 1 wherein the segments in the circumferentially extending groove have different circumferential lengths.

11. The tire of claim 1 wherein the tread has two repeating segment circumferentially extending grooves.

12. The tire of claim 1 wherein the circumferentially extending groove is located in only one half of the tread.
